(19) United States
(12) Patent Application Publication
(10) Pub. No.: US 2021/0367304 A1
(43) Pub. Date: Nov. 25, 2021

(54) COMBINATION OF CONTAINER AND MOUNTABLE COMPONENT, AND CONTAINER

(71) Applicant: TOYOTA JIDOSHA KABUSHIKI KAISHA, Aichi-ken (JP)

(72) Inventor: Yuta TAKAHASHI, Toyota-shi (JP)

(21) Appl. No.: 17/240,911

(22) Filed: Apr. 26, 2021

(30) Foreign Application Priority Data
May 19, 2020 (JP) 2020-087475

(51) Int. Cl. H01M 50/291; H01M 50/209

(52) U.S. Cl. CPC H01M 50/291; H01M 50/209

(57) ABSTRACT

There is provided a combination of a container and a mountable component that can ensure the mountability of the mountable component to the container and achieve a reduction in size of the container to which the mountable component is mounted. The container includes a wall portion including an outer surface, and a rib-like guide portion protruding from the outer surface. The mountable component includes a projecting portion that engages with the container in a state where the mountable component is mounted to the outer surface of the container. The guide portion includes a positioning portion that positions the projecting portion with respect to the outer surface.

This nonprovisional application is based on Japanese Patent Application No. 2020-087475 filed on May 19, 2020 with the Japan Patent Office, the entire contents of which are hereby incorporated by reference.

### BACKGROUND

### Field

The present disclosure relates to a combination of a container and a mountable component, and a container.

### Description of the Background Art

For example, Japanese Patent Laying-Open No. 2014-019260 describes the technique of using a positioning pin to perform positioning when mounting a battery pack mounted on a vehicle to a vehicle body.

### SUMMARY

When a device such as a battery electronic control unit (ECU) that performs prescribed processing about a battery is mounted to a container that houses a battery stack, the device may be moved downward from above and mounted such that an engagement portion on the device side engages with a positioning pin of the container.

A margin is set in the container in order to ensure the mountability and quality of the device when the device is mounted to the container, and to ensure a gap for dealing with dimensional variations of each component and ensure a gap for the mounting work. The margin leads to an increase in size of the container and complication of a structure.

The present disclosure suggests a combination of a container and a mountable component that can ensure the mountability of the mountable component to the container and achieve a reduction in size of the container to which the mountable component is mounted.

According to the present disclosure, a combination of a container and a mountable component mountable to the container is suggested. The container includes a wall portion including an outer surface, and a rib-like guide portion protruding from the outer surface. The mountable component includes a projecting portion that engages with the container in a state where the mountable component is mounted to the outer surface of the container. The guide portion includes a positioning portion that positions the projecting portion with respect to the outer surface.

According to such a configuration, when the mountable component is mounted to the container, it is possible to relatively move the mountable component with respect to the container while moving the projecting portion along the guide portion, and thus, the mountability of the mountable component to the container is ensured. Since the container includes the guide portion serving as a guide during mounting of the mountable component, a gap for the mounting work can be omitted, which allows a reduction in size of the container.

In the above-described combination, the guide portion may extend at least in a vertical direction. In this case, by relatively moving the mountable component with respect to the container in the vertical direction while moving the projecting portion along the guide portion, the mountable component can be mounted to the container.

In the above-described combination, the guide portion may include the positioning portion at a lower end of the guide portion. By moving downward the mountable component from above with respect to the container while moving the projecting portion along the guide portion, and then, positioning the projecting portion by the positioning portion, the mountable component can be mounted to the container at an appropriate position.

In the above-described combination, the positioning portion may be open upwardly. In this case, with the relative movement for moving downward the mountable component from above with respect to the container, the projecting portion can reliably engage with the positioning portion.

In the above-described combination, the guide portion may include an upper guide portion extending in the vertical direction, and a lower guide portion extending in the vertical direction at a position displaced from a position of the upper guide portion. It is possible to move downward the projecting portion along the upper guide portion, and displace the position of the projecting portion and move downward the projecting portion along the lower guide portion after the projecting portion reaches a lower end of the upper guide portion. Therefore, flexibility of arrangement of the mountable component with respect to the container can be increased.

In the above-described combination, the guide portion may include a horizontal guide portion connecting to a lower end of the upper guide portion and an upper end of the lower guide portion, and extending in a horizontal direction. Since it is possible to move the projecting portion along the horizontal guide portion when displacing the position of the projecting portion from the upper guide portion to the lower guide portion, the mountability of the mountable component to the container can be further improved.

In the above-described combination, the projecting portion may have an outer diameter larger than an inner diameter of the positioning portion in a state where the mountable component is not mounted to the container. Thus, the mountable component can be positioned without rattling when the mountable component is mounted to the container, which allows a further reduction in size of the container.

In the above-described combination, the projecting portion may be elastically deformable, and the projecting portion may be compressed and deformed in a state where the mountable component is mounted to the container. Since the projecting portion is elastically deformable, the mountability of the mountable component to the container can be improved. Since the projecting portion is compressed and deformed in a state where the mountable component is mounted to the container, the mountable component is supported due to the frictional force generated between the guide portion and the projecting portion, and thus, the mountable component is supported more stably. Therefore, input of vibrations into the mountable component can be reduced and the reliability of the mountable component can be improved.

In the above-described combination, a battery stack formed by stacking a plurality of battery cells may be housed in the container, and the wall portion may face the battery stack in a stacking direction of the battery cells. Of the wall portion of the container, the outer surface that has conventionally included a reinforcing rib in order to ensure the strength is provided with the guide portion, and thus, it is unnecessary to add a new configuration for guiding the projecting portion during mounting of the mountable component to the container. The container is produced by die casting, and thus, the container, the reinforcing rib and the guide portion can be integrally molded simultaneously. Therefore, the container including the guide portion can be achieved without causing an increase in mass of the container and an increase in cost.

According to the present disclosure, a container including: a wall portion including an outer surface; and a rib-like guide portion protruding from the outer surface is suggested. A mountable component mountable to the container includes a projecting portion that engages with the container in a state where the mountable component is mounted to the outer surface of the container. The guide portion includes a positioning portion that positions the projecting portion with respect to the outer surface.

According to such a configuration, when the mountable component is mounted to the container, it is possible to relatively move the mountable component with respect to the container while moving the projecting portion along the guide portion, and thus, the mountability of the mountable component to the container is ensured. Since the container includes the guide portion serving as a guide during mounting of the mountable component, a gap for the mounting work can be omitted, which allows a reduction in size of the container.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view of a container according to a first embodiment.

FIG. 2 is a partial cross-sectional view of the container taken along line II-II shown in FIG. 1.

FIG. 3 is a side view of the container and a mountable component mounted to the container.

FIG. 4 is a partial cross-sectional view of the container and the mountable component taken along line IV-IV shown in FIG. 3.

FIG. 5 is a schematic view showing a first step of mounting the mountable component to the container.

FIG. 6 is a schematic view showing a second step of mounting the mountable component to the container.

FIG. 7 is a schematic view showing a third step of mounting the mountable component to the container.

FIG. 8 is a schematic view showing a first step of mounting a mountable component to a container according to a second embodiment.

FIG. 9 is a schematic view showing a second step of mounting the mountable component to the container according to the second embodiment.

FIG. 10 is a schematic view showing a third step of mounting the mountable component to the container according to the second embodiment.

### DESCRIPTION OF THE PREFERRED EMBODIMENTS

Embodiments will be described hereinafter with reference to the drawings. In the following description, the same components are denoted by the same reference characters. Their names and functions are also the same. Therefore, detailed description about them will not be repeated.

### First Embodiment

(Container 20)

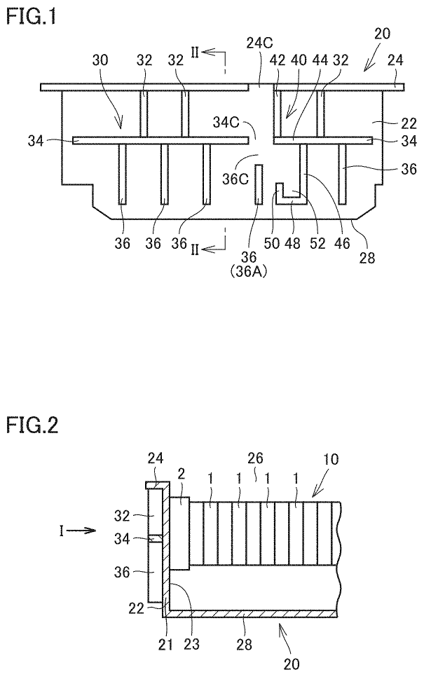

FIG. 1 is a side view of a container 20 according to a first embodiment. FIG. 2 is a partial cross-sectional view of container 20 taken along line II-II shown in FIG. 1. FIG. 1 illustrates container 20 viewed from an arrow I direction shown in FIG. 2. As shown in FIGS. 1 and 2, container 20 includes an opening 26 and a bottom portion 28. Container 20 has a bottomed box shape with an upper part being open. The inside of container 20 is hollow. In the present specification, a direction from opening 26 toward bottom portion 28 of container 20 (vertical direction in FIGS. 1 and 2) is referred to as a vertical direction, and a direction orthogonal to the vertical direction is referred to as a horizontal direction.

Container 20 has a substantially rectangular shape in a plan view and includes a wall portion 21 that forms one side of the rectangular shape. Wall portion 21 includes an outer surface 22 facing outward of container 20, and an inner surface 23 facing inward of container 20 and being opposite to outer surface 22. At upper ends of wall portion 21 and the other wall portions that form the other sides of the rectangular shape, container 20 includes an edge 24 protruding outward of container 20.

A battery stack 10 is housed in container 20. Battery stack 10 is formed by stacking a plurality of battery cells 1. Each battery cell 1 includes a battery element, a housing that houses the battery element, and an external terminal arranged outside the housing. End plates 2 are provided at both ends in a stacking direction with respect to a stacked body of battery cells 1. A restraint load that restrains battery cells 1 by sandwiching battery cells 1 from both sides in the stacking direction is applied to end plates 2 by a not-shown restraint member.

Wall portion 21 faces battery stack 10 in the stacking direction (lateral direction in FIG. 2) of battery cells 1. End plate 2 is in contact with inner surface 23 of wall portion 21 of container 20. End plate 2 applies reaction force of the above-described restraint load to wall portion 21 of container 20.

Container 20 includes a reinforcing rib 30 on outer surface 22 of wall portion 21 in order to increase the strength of wall portion 21 that receives the reaction force of the restraint load from end plate 2. Reinforcing rib 30 has a shape of protruding perpendicularly from outer surface 22. Reinforcing rib 30 includes a plurality of upper ribs 32, a horizontal rib 34, and a plurality of lower ribs 36, the number of lower ribs 36 being larger than that of upper ribs 32.

Upper rib 32 extends in the vertical direction. Horizontal rib 34 extends in the horizontal direction. Lower rib 36 extends in the vertical direction. A lower end of each of the plurality of upper ribs 32 arranged in parallel connects to horizontal rib 34. Upper rib 32 includes an upper end connecting to edge 24, and the lower end connecting to horizontal rib 34. An upper end of each of the plurality of lower ribs 36 arranged in parallel connects to horizontal rib 34. Lower rib 36 includes the upper end connecting to horizontal rib 34.

Container 20 also includes a guide portion 40 on outer surface 22. Guide portion 40 has a rib-like shape of protruding perpendicularly from outer surface 22. Guide portion 40 shown in FIG. 1 includes an upper guide portion 42, a horizontal guide portion 44, a lower guide portion 46, a lower end portion 48, and a hook forming portion 50. Upper guide portion 42 extends in the vertical direction. Lower guide portion 46 extends in the vertical direction at a position displaced from a position of upper guide portion 42. Horizontal guide portion 44 connects to a lower end of upper guide portion 42 and an upper end of lower guide portion 46, and extends in the horizontal direction. Upper guide portion 42 includes an upper end connecting to edge 24, and the lower end connecting to horizontal guide portion 44. Lower guide portion 46 includes the upper end connecting to horizontal guide portion 44.

Lower end portion 48 connects to a lower end of lower guide portion 46 and extends in the horizontal direction. Hook forming portion 50 connects to the other end of lower end portion 48 opposite to one end of lower end portion 48 connecting to lower guide portion 46, and extends in the vertical direction. Hook forming portion 50 extends upwardly from lower end portion 48. Guide portion 40 has a hook shape at a lower end. As shown in FIG. 1, a positioning portion 52 surrounded by lower guide portion 46, lower end portion 48 and hook forming portion 50 is provided at the lower end of guide portion 40. Positioning portion 52 is open upwardly.

Right next to a portion connecting to the upper end of upper guide portion 42, edge 24 is provided with a cutout 24C formed by removing a part of edge 24. Right next to a portion connecting to the lower end of upper guide portion 42, horizontal rib 34 is provided with a cutout 34C formed by removing a part of horizontal rib 34. Of the plurality of lower ribs 36, a lower rib 36A located adjacent to guide portion 40 and below cutouts 24C and 34C is provided with a cutout 36C formed by removing a part of an upper end of lower rib 36A. Unlike the other lower ribs 36, the upper end of lower rib 36A does not connect to horizontal rib 34.

(Combination of Container 20 and Mountable Component 60)

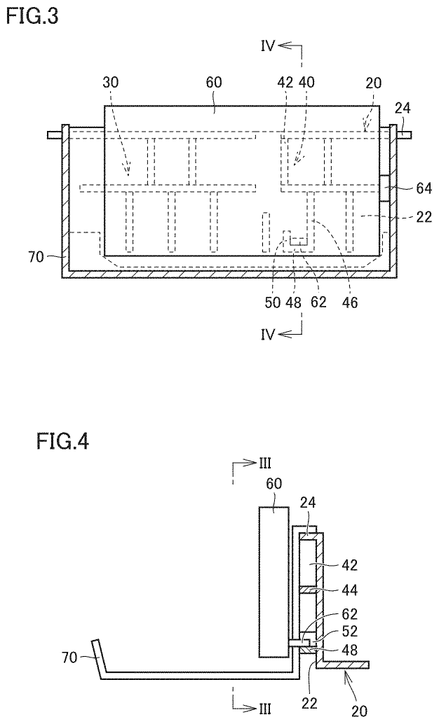

FIG. 3 is a side view of container 20 and a mountable component 60 mounted to container 20. FIG. 4 is a partial cross-sectional view of container 20 and mountable component 60 taken along line IV-IV shown in FIG. 3. FIG. 3 shows a partial cross-sectional view of a combination of container 20 and mountable component 60 taken along line shown in FIG. 4. Mountable component 60 is mounted to outer surface 22 of container 20. Mountable component 60 is, for example, a battery ECU that performs prescribed processing about battery stack 10.

Mountable component 60 includes a projecting portion 62. Projecting portion 62 has a shape of protruding from a main body portion of mountable component 60. In a state where mountable component 60 is mounted to container 20, projecting portion 62 faces container 20. In a state where mountable component 60 is mounted to outer surface 22 of container 20, projecting portion 62 engages with container 20. Specifically, projecting portion 62 is housed in positioning portion 52 located at the lower end of guide portion 40. Positioning of projecting portion 62 with respect to outer surface 22 is thus performed.

A cover member 70 covers mountable component 60. Cover member 70 prevents mountable component 60 from being exposed, to thereby suppress physical contact of another component with mountable component 60. In addition, cover member 70 ensures a distance between mountable component 60 and another peripheral component and exists as a reflecting member, to thereby reduce input of electromagnetic noise from another component to mountable component 60.

Mountable component 60 includes a connector 64. A portion of cover member 70 corresponding to connector 64 is provided with a hole that penetrates cover member 70. Through this hole, the wiring work from outside to connector 64 is performed.

(Method for Assembling Mountable Component 60 to Container 20)

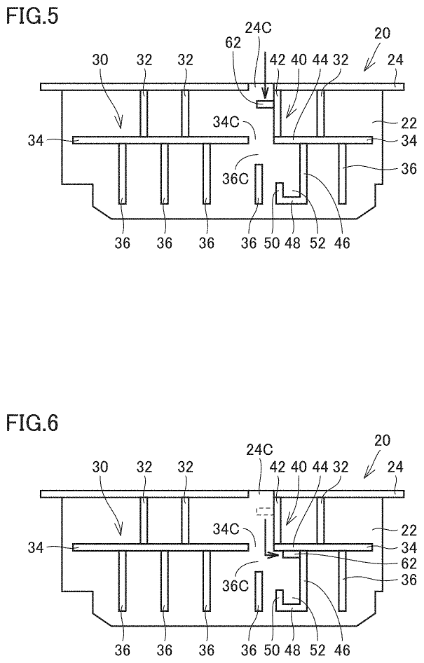

A method for assembling mountable component 60 to container 20 will be described hereinafter. In the following figures, for the sake of simplification, the main body portion of mountable component 60 is not shown and only projecting portion 62 of mountable component 60 is shown, to describe a relative movement of projecting portion 62 with respect to container 20. Arrows in FIG. 5 and the subsequent figures indicate a direction of movement of projecting portion 62.

FIG. 5 is a schematic view showing a first step of mounting mountable component 60 to container 20. When mountable component 60 is mounted to container 20, mountable component 60 is moved downward from above with respect to container 20, such that mountable component 60 comes closer to container 20 from above. As shown in FIG. 5, projecting portion 62 is moved downward to pass through cutout 24C formed in edge 24. Mountable component 60 is moved downward, while keeping projecting portion 62 in contact with guide portion 40, and specifically upper guide portion 42, and moving projecting portion 62 along upper guide portion 42.

FIG. 6 is a schematic view showing a second step of mounting mountable component 60 to container 20. Mountable component 60 is further moved downward, while keeping projecting portion 62 in contact with upper guide portion 42. When projecting portion 62 reaches the lower end of upper guide portion 42, projecting portion 62 is brought into contact with horizontal guide portion 44, and mountable component 60 is moved in the horizontal direction, while keeping projecting portion 62 in contact with horizontal guide portion 44. Until projecting portion 62 comes into contact with lower guide portion 46, movement of mountable component 60 while moving projecting portion 62 along horizontal guide portion 44 is continued.

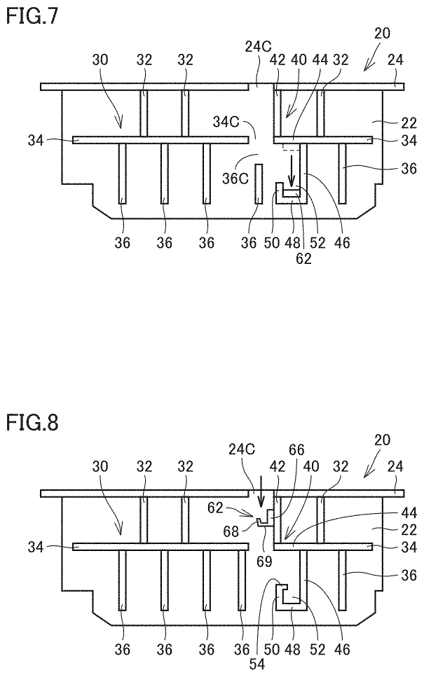

FIG. 7 is a schematic view showing a third step of mounting mountable component 60 to container 20. Mountable component 60 is further moved downward, while keeping projecting portion 62 in contact with lower guide portion 46. Until projecting portion 62 reaches the lower end of lower guide portion 46 and comes into contact with lower end portion 48, mountable component 60 is moved downward. Projecting portion 62 is surrounded by lower guide portion 46, lower end portion 48 and hook forming portion 50. Projecting portion 62 is housed in positioning portion 52. In this way, positioning of projecting portion 62 with respect to guide portion 40 is performed, and thus, positioning of mountable component 60 with respect to container 20 is performed. As a result, mountable component 60 is mounted to container 20.

(Functions and Effects)

Although there is a partial overlap with the foregoing description, characteristic configurations and functions and effects of container 20 and mountable component 60 according to the embodiment will be summarized below.

As shown in FIGS. 1 and 2, container 20 includes wall portion 21 including outer surface 22, and rib-like guide portion 40 protruding from outer surface 22. As shown in FIGS. 3 and 4, mountable component 60 includes projecting portion 62. Projecting portion 62 engages with container 20 in a state where mountable component 60 is mounted to outer surface 22 of container 20. Guide portion 40 includes positioning portion 52 that positions projecting portion 62 with respect to outer surface 22 of container 20.

When mountable component 60 is mounted to container 20, it is possible to relatively move mountable component 60 with respect to container 20 while moving projecting portion 62 along a surface of guide portion 40, and mount mountable component 60 to container 20 at a defined position where projecting portion 62 is positioned by positioning portion 52. Thus, the mountability of mountable component 60 to container 20 is ensured.

Since container 20 includes guide portion 40 serving as a guide for defining the path of mountable component 60 during mounting of mountable component 60, mountable component 60 can be easily mounted to container 20 without the need to set a gap for the mounting work in container 20. A gap corresponding to dimensional variations of each of container 20 and mountable component 60 may only be ensured for container 20 to which mountable component 60 is mounted, and thus, the gap for the mounting work can be omitted. Therefore, a reduction in size of container 20 can be achieved by downsizing container 20, and mounting of mountable component 60 to container 20 in a space-saving manner can be achieved.

As shown in FIGS. 1 to 4, guide portion 40 includes a portion extending in the vertical direction. This makes it possible to relatively move mountable component 60 with respect to container 20 in the vertical direction while moving projecting portion 62 along guide portion 40, and mount mountable component 60 to container 20 at an appropriate position.

As shown in FIGS. 1 and 3, guide portion 40 includes positioning portion 52 at the lower end of guide portion 40. By moving downward mountable component 60 from above with respect to container 20 while moving projecting portion 62 along guide portion 40, and then, positioning projecting portion 62 by positioning portion 52, mountable component 60 can be mounted to container 20 at an appropriate position. Since a part of the shape of guide portion 40 has the function of finally positioning mountable component 60 with respect to container 20, a positioning pin or the like is unnecessary to position mountable component 60, and thus, the number of components in container 20 and mountable component 60 can be reduced.

As shown in FIGS. 1 and 3, positioning portion 52 is open upwardly. Thus, with the relative movement of mountable component 60 with respect to container 20 for moving downward mountable component 60 from above with respect to container 20, projecting portion 62 can reliably engage with positioning portion 52.

As shown in FIGS. 1 and 3, guide portion 40 includes upper guide portion 42 extending in the vertical direction, and lower guide portion 46 extending in the vertical direction at a position displaced from a position of upper guide portion 42. During relative movement for moving downward mountable component 60 from above with respect to container 20, it is possible to move downward projecting portion 62 along upper guide portion 42, and displace the position of projecting portion 62 and move downward projecting portion 62 along lower guide portion 46 after projecting portion 62 reaches the lower end of upper guide portion 42. Therefore, flexibility of arrangement of mountable component 60 with respect to container 20 can be increased. For example, connector 64 shown in FIG. 3 can be arranged closer to cover member 70, and thus, the workability of wiring to connector 64 can be improved.

Immediately before the end of the work for mounting mountable component 60 to container 20, mountable component 60 is moved to come closer to cover member 70. Therefore, interference between mountable component 60 and cover member 70 during the mounting work can be suppressed.

As shown in FIGS. 1 and 3, guide portion 40 includes horizontal guide portion 44 connecting to the lower end of upper guide portion 42 and the upper end of lower guide portion 46, and extending in the horizontal direction. It is possible to move projecting portion 62 along horizontal guide portion 44 when displacing the position of projecting portion 62 from upper guide portion 42 to lower guide portion 46. Thus, the mountability of mountable component 60 to container 20 can be further improved.

As shown in FIG. 2, battery stack 10 formed by stacking a plurality of battery cells 1 is housed in container 20. Wall portion 21 of container 20 having guide portion 40 on outer surface 22 thereof faces battery stack 10 in the stacking direction of battery cells 1.

Of the wall portion of container 20, outer surface 22 that includes reinforcing rib 30 in order to obtain the strength for restraining battery stack 10 is provided with guide portion 40. On outer surface 22 that has conventionally included reinforcing rib 30 in order to ensure the rigidity of container 20, guide portion 40 that defines a path when mounting mountable component 60 to container 20 can be formed by changing the shape of a part of reinforcing rib 30. Thus, it is unnecessary to add a new configuration for guiding projecting portion 62 during mounting of mountable component 60 to container 20.

Container 20 is produced by die casting, which leads to a high degree of flexibility of the shape of container 20. Container 20, reinforcing rib 30 and guide portion 40 can be integrally molded simultaneously by die casting. More specifically, a die having shapes corresponding to reinforcing rib 30 and guide portion 40 is prepared, and die cutting is performed in a direction perpendicular to outer surface 22. Outer surface 22 including reinforcing rib 30 and guide portion 40 having arbitrary shapes can thus be molded. Therefore, container 20 including guide portion 40 can be achieved without causing an increase in mass of container 20 and an increase in cost.

### Second Embodiment

FIG. 8 is a schematic view showing a first step of mounting mountable component 60 to container 20 according to a second embodiment. Container 20 according to the second embodiment is different in arrangement of reinforcing rib 30 from container 20 according to the first embodiment. Specifically, in reinforcing rib 30 according to the second embodiment, lower rib 36 is not arranged below cutout 34C formed in horizontal rib 34. A position of lower rib 36 provided with cutout 36C in FIG. 1 is displaced in a left direction in FIG. 8, and an upper end of lower rib 36 connects to horizontal rib 34 without cutout 36C.

In addition, container 20 according to the second embodiment is different in a shape of guide portion 40 from container 20 according to the first embodiment. Specifically, guide portion 40 according to the second embodiment includes a return portion 54. Return portion 54 connects to an upper end of hook forming portion 50 and extends from hook forming portion 50 toward lower guide portion 46. Similarly to the first embodiment, in guide portion 40 according to the second embodiment, positioning portion 52 is open upwardly. However, return portion 54 is provided, and thus, an opening of positioning portion 52 is narrower than that in the first embodiment.

In addition, mountable component 60 according to the second embodiment is different in a shape of projecting portion 62 from mountable component 60 according to the first embodiment. Specifically, projecting portion 62 according to the second embodiment includes a main portion 66, a sub portion 68 and a coupling portion 69. Projecting portion 62 as a whole has a shape similar to the upper case of letter “J” of the alphabet. Projecting portion 62 can be formed, for example, by bending and deforming a plate member.

Main portion 66 is fixed to the main body portion of mountable component 60. Coupling portion 69 has a shape of coupling main portion 66 to sub portion 68. Sub portion 68 is not directly mounted to the main body portion of mountable component 60. Sub portion 68 is mounted to the main body portion of mountable component 60, with coupling portion 69 and main portion 66 being interposed. Sub portion 68 is configured to be relatively movable with respect to main portion 66 and the main body portion of mountable component 60. As a result, projecting portion 62 is elastically deformable. Projecting portion 62 has a horizontal spring structure.

Projecting portion 62 has an outer diameter larger than an inner diameter of positioning portion 52 in a state where mountable component 60 is not mounted to container 20. For example, shapes of projecting portion 62 and positioning portion 52 are set, for example, such that a space between a surface of main portion 66 not facing sub portion 68 and a surface of sub portion 68 not facing main portion 66 is larger than a space between a surface of lower guide portion 46 facing hook forming portion 50 and a surface of hook forming portion 50 facing lower guide portion 46.

Similarly to the first embodiment, when mountable component 60 is mounted to container 20, mountable component 60 is moved downward from above with respect to container 20, such that mountable component 60 comes closer to container 20 from above. As shown in FIG. 8, projecting portion 62 is moved downward to pass through cutout 24C formed in edge 24. Mountable component 60 is moved downward, while moving projecting portion 62 along guide portion 40, and specifically moving main portion 66 along upper guide portion 42.

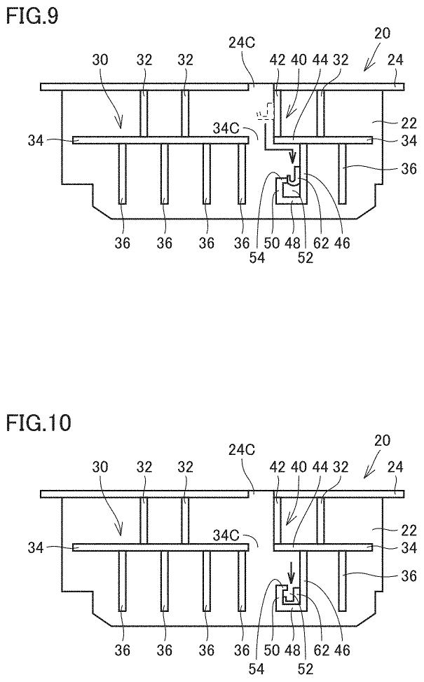

FIG. 9 is a schematic view showing a second step of mounting mountable component 60 to container 20 according to the second embodiment. Main portion 66 is moved downward along upper guide portion 42, and when main portion 66 reaches the lower end of upper guide portion 42, projecting portion 62 is moved in the horizontal direction along horizontal guide portion 44. Until main portion 66 comes into contact with lower guide portion 46, the movement of projecting portion 62 along horizontal guide portion 44 is continued. Then, projecting portion 62 is moved downward, while moving main portion 66 along lower guide portion 46.

When projecting portion 62 passes through the upward opening of positioning portion 52, projecting portion 62 is elastically deformed. Guide portion 40 includes return portion 54, and when projecting portion 62 passes through a narrowed opening between lower guide portion 46 and return portion 54, projecting portion 62 is elastically deformed such that sub portion 68 comes closer to main portion 66. Since projecting portion 62 is elastically deformed to reduce a space between main portion 66 and sub portion 68, projecting portion 62 can pass through the opening between lower guide portion 46 and return portion 54.

FIG. 10 is a schematic view showing a third step of mounting mountable component 60 to container 20 according to the second embodiment. Projecting portion 62 is further moved downward along lower guide portion 46 to pass through the opening between lower guide portion 46 and return portion 54. Projecting portion 62 is housed in positioning portion 52. In this way, positioning of projecting portion 62 with respect to container 20 is performed, and thus, positioning of mountable component 60 with respect to container 20 is performed. As a result, mountable component 60 is mounted to container 20.

The shapes of projecting portion 62 and positioning portion 52 are set such that the outer diameter of projecting portion 62 is larger than the inner diameter of positioning portion 52 in a no-load state. Therefore, projecting portion 62 housed in positioning portion 52 is compressed and deformed. Projecting portion 62 housed in positioning portion 52 applies stress to guide portion 40 such that main portion 66 presses lower guide portion 46 and sub portion 68 presses hook forming portion 50.

In mountable component 60 according to the second embodiment described above, projecting portion 62 has the outer diameter larger than the inner diameter of positioning portion 52 in a state where mountable component 60 is not mounted to container 20 and thus no load is applied to projecting portion 62. In a state where projecting portion 62 is housed in positioning portion 52, lower guide portion 46 is in surface contact with main portion 66 of projecting portion 62 and hook forming portion 50 is in surface contact with sub portion 68. Thus, mountable component 60 can be positioned without rattling when mountable component 60 is mounted to container 20, which allows a further reduction in size of container 20.

Since projecting portion 62 is elastically deformable, projecting portion 62 having a span length greater than that of positioning portion 52 can be easily housed in positioning portion 52. Thus, the mountability of mountable component 60 to container 20 can be improved.

Since guide portion 40 includes return portion 54 and the upward opening of positioning portion 52 is narrowed, the elastic deformation of projecting portion 62 during passage through the opening is partially restored after passage through the opening. Such deformation of projecting portion 62 allows an operator to feel that projecting portion 62 is fitted when projecting portion 62 passes through the opening. Therefore, the mountability of mountable component 60 to container 20 can be further improved.

Projecting portion 62 is compressed and deformed in a state where mountable component 60 is mounted to container 20 and thus in a state where projecting portion 62 is housed in positioning portion 52. Mountable component 60 is supported due to the frictional force generated between guide portion 40 and projecting portion 62. The number of support points for mountable component 60 increases, and thus, mountable component 60 is supported more stably. Therefore, input of vibrations into mountable component 60 can be reduced and the reliability of mountable component 60 can be improved.

The foregoing description of the embodiments has illustrated the example in which guide portion 40 includes upper guide portion 42 and lower guide portion 46 extending in the vertical direction and horizontal guide portion 44 extending in the horizontal direction. However, guide portion 40 may have an arbitrary shape as long as it can define the path of mountable component 60 during mounting of mountable component 60 to container 20.

The embodiments have illustrated the example in which reinforcing rib 30 is provided with the cutout along the path of projecting portion 62 during mounting of mountable component 60 to container 20. However, reinforcing rib 30 may have an arbitrary shape as long as reinforcing rib 30 does not interfere with projecting portion 62 and does not block the relative movement of mountable component 60 with respect to container 20. For example, a position of a part of reinforcing rib 30 may be displaced. Reinforcing rib 30 may be provided with a step formed by reducing a protruding height of a part of reinforcing rib 30 from outer surface 22.

Although the embodiments have illustrated the example in which container 20 is a case that houses battery stack 10, the present disclosure is not limited to this example. The idea of the embodiments is also applicable to an arbitrary container and an arbitrary mountable component mountable to the container.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A combination of a container and a mountable component mountable to the container, wherein
the container comprises a wall portion including an outer surface, and a rib-like guide portion protruding from the outer surface,
the mountable component comprises a projecting portion that engages with the container in a state where the mountable component is mounted to the outer surface of the container, and
the guide portion comprises a positioning portion that positions the projecting portion with respect to the outer surface.

2. The combination of the container and the mountable component according to claim 1, wherein
the guide portion extends at least in a vertical direction.

3. The combination of the container and the mountable component according to claim 2, wherein
the guide portion includes the positioning portion at a lower end of the guide portion.

4. The combination of the container and the mountable component according to claim 2, wherein
the positioning portion is open upwardly.

5. The combination of the container and the mountable component according to claim 2, wherein
the guide portion includes an upper guide portion extending in the vertical direction, and a lower guide portion extending in the vertical direction at a position displaced from a position of the upper guide portion.

6. The combination of the container and the mountable component according to claim 5, wherein
the guide portion includes a horizontal guide portion connecting to a lower end of the upper guide portion and an upper end of the lower guide portion, and extending in a horizontal direction.

7. The combination of the container and the mountable component according to claim 1, wherein
the projecting portion has an outer diameter larger than an inner diameter of the positioning portion in a state where the mountable component is not mounted to the container.

8. The combination of the container and the mountable component according to claim 7, wherein
the projecting portion is elastically deformable, and
the projecting portion is compressed and deformed in a state where the mountable component is mounted to the container.

9. The combination of the container and the mountable component according to claim 1, wherein
a battery stack formed by stacking a plurality of battery cells is housed in the container, and
the wall portion faces the battery stack in a stacking direction of the battery cells.

10. A container comprising:
a wall portion including an outer surface; and
a rib-like guide portion protruding from the outer surface, wherein
a mountable component mountable to the container comprises a projecting portion that engages with the container in a state where the mountable component is mounted to the outer surface of the container, and
the guide portion comprises a positioning portion that positions the projecting portion with respect to the outer surface.
